(19) United States
(12) Patent Application Publication
(10) Pub. No.: US 2021/0072537 A1
(43) Pub. Date: Mar. 11, 2021

(54) VEHICULAR DISPLAY DEVICE

(71) Applicant: Yazaki Corporation, Tokyo (JP)

(72) Inventors: Takuma Ogisu, Shizuoka (JP); Kunimitsu Aoki, Shizuoka (JP)

(21) Appl. No.: 17/009,785

(22) Filed: Sep. 2, 2020

(30) Foreign Application Priority Data
Sep. 5, 2019 (JP) 2019-161913

(51) Int. Cl. G02B 27/01; B60K 35/00

(52) U.S. Cl. CPC G02B 27/0103; B60K 35/00; G02B 2027/0118; B60K 2370/785; B60K 2370/29; B60K 2370/334; B60K 2370/1529

(57) ABSTRACT

A vehicular display device includes: a reflection-type hologram disposed inside a windshield of a vehicle and including a first surface facing a side of an eye range of the vehicle; and a projection device that projects display light of a P wave toward the first surface. The hologram outputs the display light, which is incident on the first surface from the projection device, as diffracted light directed to the eye range, and has diffraction characteristics of condensing the diffracted light in the eye range. The projection device is disposed such that a part of the display light is reflected toward the eye range when an incident angle of the display light on the windshield is within a predetermined angle range.

### CROSS-REFERENCE TO RELATED APPLICATION(S)

The present application claims priority to and incorporates by reference the entire contents of Japanese Patent Application No. 2019-161913 filed in Japan on Sep. 5, 2019.

### BACKGROUND OF THE INVENTION

### 1. Field of the Invention

The present invention relates to a vehicular display device.

### 2. Description of the Related Art

In the related art, there is a display device using a hologram. Japanese Patent Application Laid-open No. 11-91401 discloses a vehicular holographic display device including an information display source that generates information to be displayed as light, and a combiner having a hologram that is arranged in a dark color concealing part provided on a peripheral edge part of a windshield of a vehicle, diffracts light toward an observer, and displays the light as a virtual image.

When the hologram is disposed inside the windshield, it is necessary to consider the reflection of the display light by the surface of the windshield. From the standpoint of improving the visibility of the display image, it is preferable to dispose a projection device such that reflected light is directed in a direction different from the eye range. However, since there is a mounting position limitation in the vehicle, it is not always possible to dispose the projection device at a desired position.

### SUMMARY OF THE INVENTION

An object of the present invention is to provide a vehicular display device capable of improving the visibility of a display image and improving the degree of freedom in the arrangement of a projection device.

A vehicular display device according to one aspect of the present invention includes a reflection-type hologram disposed inside a windshield of a vehicle and including a first surface facing a side of an eye range of the vehicle; and a projection device that projects display light of a P wave toward the first surface, wherein the hologram outputs the display light, which is incident on the first surface from the projection device, as diffracted light directed to the eye range, and has diffraction characteristics of condensing the diffracted light in the eye range, the projection device is disposed such that a part of the display light is reflected toward the eye range when an incident angle of the display light on the windshield is within a predetermined angle range, and the projection device is disposed such that an angle difference between the incident angle included in the predetermined angle range and a Brewster angle is equal to or less a predetermined value.

According to another aspect of the present invention, in the vehicular display device, it is preferable that the projection device is disposed such that the predetermined angle range includes the Brewster angle.

According to still another aspect of the present invention, in the vehicular display device, it is preferable that the projection device is disposed such that a brightness ratio between brightness of reflected light reflected by the windshield toward the eye range and brightness of the diffracted light is equal to or less than a predetermined value.

According to still another aspect of the present invention, in the vehicular display device, it is preferable that the brightness of the reflected light includes brightness of light reflected by a surface of the windshield on a vehicle interior side and brightness of light reflected by a boundary surface between the windshield and an outside of the vehicle after passing through the surface on the vehicle interior side.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic configuration diagram of a vehicular display device according to an embodiment;

FIG. 2 is a diagram explaining the diffraction of light by a hologram according to the embodiment;

FIG. 3 is a diagram explaining light reflected by a windshield;

FIG. 4 is a diagram explaining first reflected light and second reflected light of the embodiment;

FIG. 5 is a diagram illustrating reflection characteristics in the windshield of the embodiment; and

FIG. 6 is a diagram explaining a method for determining the arrangement of a projection device according to the embodiment.

### DETAILED DESCRIPTION OF THE PREFERRED EMBODIMENTS

Hereinafter, a vehicular display device according to an embodiment of the present invention will be described in detail with reference to the drawings. Note that the invention is not limited by the embodiment. Furthermore, constituent elements in the following embodiment include those that can be easily arrived at by a person skilled in the art or those that are substantially the same.

### Embodiment

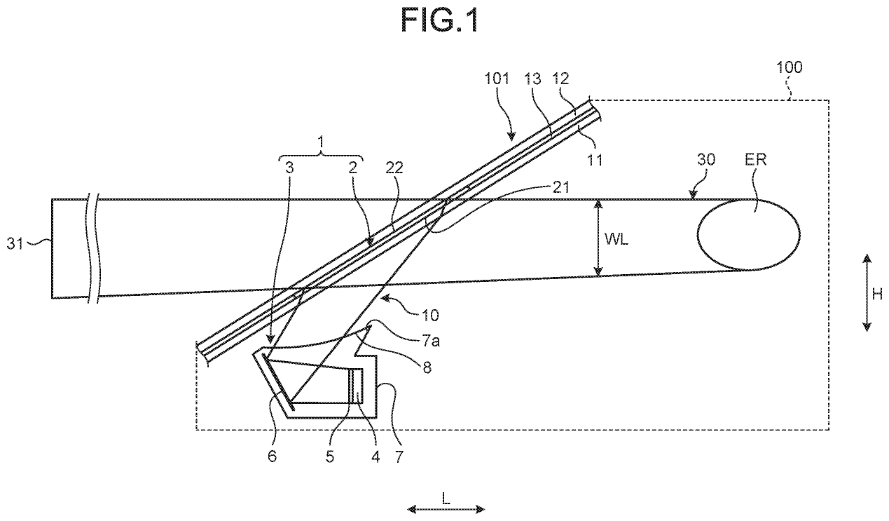

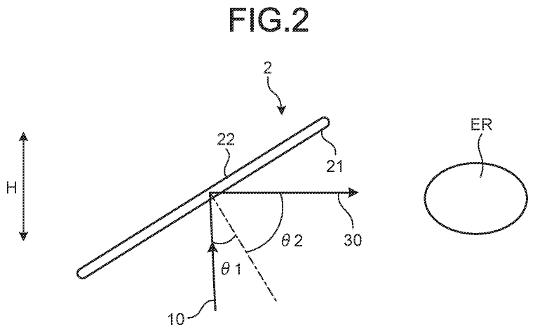

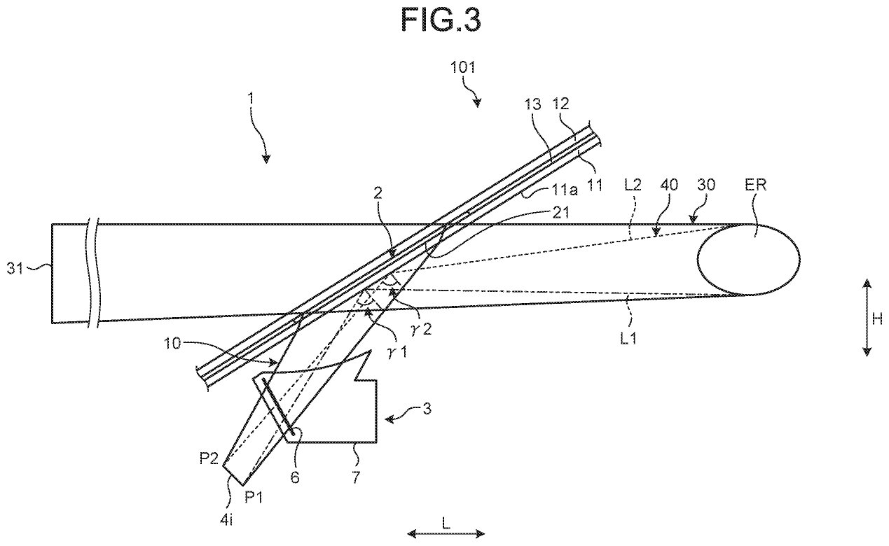

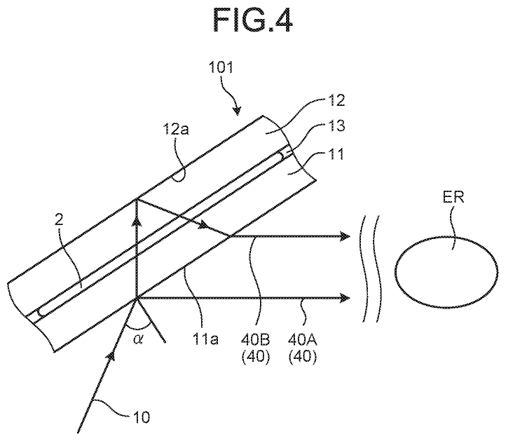

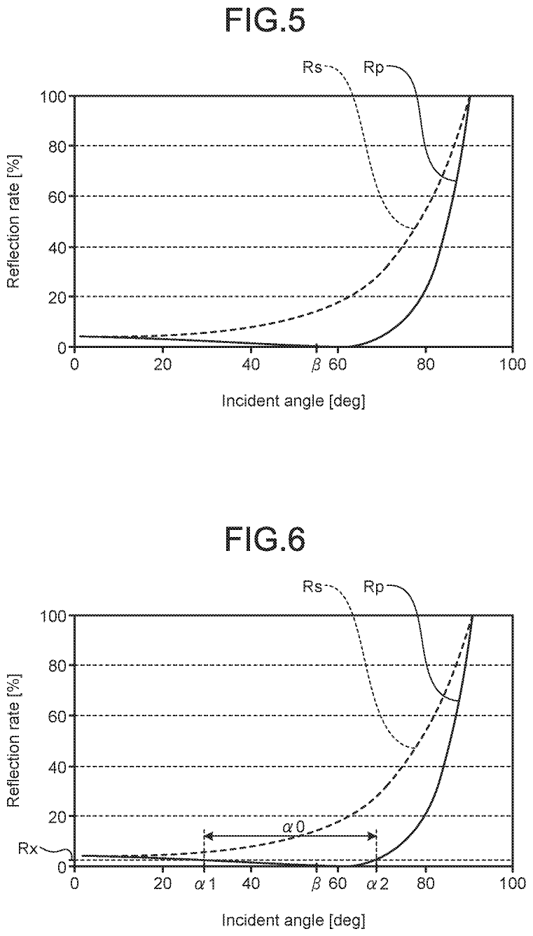

With reference to FIG. 1 to FIG. 6, the embodiment will be described. The present embodiment relates to a vehicular display device. FIG. 1 is a schematic configuration diagram of a vehicular display device according to an embodiment; FIG. 2 is a diagram explaining the diffraction of light by a hologram according to the embodiment; FIG. 3 is a diagram explaining light reflected by a windshield; FIG. 4 is a diagram explaining first reflected light and second reflected light of the embodiment; FIG. 5 is a diagram illustrating reflection characteristics in the windshield of the embodiment; and FIG. 6 is a diagram explaining a method for determining the arrangement of a projection device according to the embodiment.

As illustrated in FIG. 1, a vehicular display device 1 of the present embodiment is a head-up display device mounted on a vehicle 100 such as an automobile. The vehicular display device 1 has a hologram 2 and a projection device 3. The hologram 2 is disposed inside a windshield 101 of the vehicle 100. The windshield 101 is a laminated glass and has an inner glass 11, an outer glass 12, and an intermediate film 13. The intermediate film 13 and the hologram 2 are sealed between the inner glass 11 and the outer glass 12. The intermediate film 13 is made of a synthetic resin such as polymer. The hologram 2 may be integrally formed with the intermediate film 13 or may be inserted into the intermediate film 13, for example.

The hologram 2 is a transparent film processed to have desired diffraction characteristics. The hologram 2 of the present embodiment is a reflection-type hologram. The hologram 2 has a first surface 21 and a second surface 22. The hologram 2 diffracts light incident on the first surface 21 and emits the diffracted light from the first surface 21.

As illustrated in FIG. 2, when light is incident on the first surface 21 at a first angle θ1, the hologram 2 outputs diffracted light 30 from the first surface 21. The hologram 2 is formed such that the emission angle of the diffracted light 30 is a second angle θ2. The second angle θ2 is determined such that the diffracted light 30 is directed to an eye range ER. The eye range ER is a region assumed as the position of eyes of a driver in the vehicle 100. In the hologram 2 of the present embodiment, the first angle θ1 and the second angle θ2 differ depending on positions along a height direction H. As will be described below, the hologram 2 is formed to condense the diffracted light 30 toward the eye range ER.

When the incident angle of light on the first surface 21 is different from the first angle θ1, the hologram 2 allows the light to pass therethrough. That is, the hologram 2 selectively reflects the light, which is incident at the first angle θ1, toward the eye range ER. Furthermore, the hologram 2 allows light incident on the second surface 22 to pass through toward the eye range ER.

The projection device 3 has a casing 7, an image display device 4, a polarizer 5, a mirror 6, and a cover 8. The casing 7 is disposed inside a dashboard of the vehicle 100, for example. The casing 7 has an opening 7a and is fixed to the vehicle 100 with the opening 7a facing upward. The dashboard is formed with an opening corresponding to the opening 7a of the casing 7. The image display device 4, the polarizer 5, and the mirror 6 are received inside the casing 7. The cover 8 closes the opening 7a of the casing 7. The cover 8 is a transparent member and allows display light 10 to pass therethrough.

The image display device 4 is a device that outputs display light, and for example, is a liquid crystal display device or a laser scanner. The polarizer 5 is an optical system that converts the display light output from the image display device 4 into a P wave. The polarizer 5 is, for example, a polarizing filter that allows the P wave selectively to pass therethrough. The display light output from the image display device 4 is polarized into the display light 10 of the P wave by passing through the polarizer 5.

The mirror 6 is a reflecting device that reflects the display light 10, which is output from the image display device 4 via the polarizer 5, toward the hologram 2. The mirror 6 of the present embodiment is a magnifying mirror. The shape of the reflecting surface of the mirror 6 is a free-form surface and the mirror 6 magnifies the display light 10 of the P wave and reflects the magnified light toward the hologram 2. That is, the projection device 3 projects the display light 10 of the P toward the first surface 21 of the hologram 2.

As illustrated in FIG. 1, the hologram 2 outputs the display light 10, which is incident from the mirror 6, as the diffracted light 30 directed to the eye range ER. When a user views the hologram 2 from the eye range ER, the diffracted light 30 causes a display image 31 to be visually recognized. The diffracted light 30 allows the user to visually recognize the display image 31 as a virtual image. The display image 31 is an image formed in front of the vehicular display device 1 in a vehicle front-rear direction L from the hologram 2.

The hologram 2 of the present embodiment has diffraction characteristics of condensing the diffracted light 30 in the eye range ER. For example, the width WL of the diffracted light 30 directed to the eye range ER becomes narrower from the hologram 2 toward the eye range ER. The width WL is the width of the diffracted light 30 in a height direction H. Note that the hologram 2 may be configured such that the width of the diffracted light 30 in a vehicle width direction also becomes narrower toward the eye range ER. The hologram 2 of the present embodiment can magnify the display image 31 and allow a user to visually recognize the magnified image.

Furthermore, the vehicular display device 1 of the present embodiment can suppress the generation of ghost due to reflected light and improve the visibility of the display image 31 as will be described below. FIG. 3 illustrates reflected light 40 reflected by the windshield 101. FIG. 3 illustrates a virtual display surface 4i instead of the image display device 4. The virtual display surface 4i is a position where the display surface of the image display device 4 is to be disposed when there is no mirror 6. When an image is displayed on the virtual display surface 4i, the image is directly projected on the hologram 2. In other words, the virtual display surface 4i is a position where a virtual image is formed when the mirror 6 is directly viewed from above.

The projection device 3 of the present embodiment is disposed such that at least a part of the display light 10 is reflected by the windshield 101 toward the eye range ER. A part of the display light 10 is reflected by the windshield 101 and becomes the reflected light 40 directed to the eye range ER. When the diffracted light 30 and the reflected light 40 reflected toward the eye range ER are superimposed, the visibility of the display image 31 may be reduced. The reflected light 40 may generate ghost overlapping the display image 31 and reduce the visibility of the display image 31. Note that, in the following description, the reflected light 40 is assumed to indicate reflected light superimposed on the display image 31.

As illustrated in FIG. 4, the reflected light 40 includes first reflected light 40A and second reflected light 40B. The first reflected light 40A is reflected light that is reflected by a surface 11a of the inner glass 11 on a vehicle interior side. The second reflected light 40B is reflected light that is reflected by a boundary surface 12a between the outer glass 12 and the outside of the vehicle. The second reflected light 40B is light in which the display light 10 passes through the surface 11a on the vehicle interior side, is incident on the inner glass 11, passes through the hologram 2, and is reflected by the boundary surface 12a.

The vehicular display device 1 of the present embodiment is configured such that the reflected light 40 becomes less visible by a user. Specifically, the projection device 3 is disposed such that an incident angle α of the display light incident on the inner glass 11 matches with the Brewster angle β of the windshield 101, or the incident angle α has a value closer to the Brewster angle β. The Brewster angle β is an angle determined by, for example, a refractive index of the inner glass 11. FIG. 5 illustrates an example of the reflection characteristics of the inner glass 11. In FIG. 5, a horizontal axis denotes the incident angle α [deg] with respect to the inner glass 11 and a vertical axis denotes a refractive index [%] of the inner glass 11. FIG. 5 illustrates a reflection rate Rs for the S wave and a reflection rate Rp for the P wave.

The reflection rate Rp for the P wave is 0 at the Brewster angle β. Accordingly, when the display light 10 of the P wave is incident on the inner glass 11 at the Brewster angle β, the reflection rate is 0 or substantially 0. In the vehicular display device 1 of the present embodiment, values of a minimum incident angle γ1 and a maximum incident angle γ2 are determined as will be described below. As illustrated in FIG. 3, the minimum incident angle γ1 is a minimum value of the incident angle α of the display light 10 that generates the reflected light 40. The display light 10 projected from one end P1 of the virtual display surface 4i is reflected toward the eye range ER when the incident angle α is within a predetermined angle range Rγ. The minimum incident angle γ1 is a minimum value of the angle range Rγ. When the incident angle α is smaller than the minimum incident angle γ1, the display light 10 at one end P1 is reflected toward a region below the eye range ER.

The display light 10 projected from the other end P2 of the virtual display surface 4i is reflected toward the eye range ER when the incident angle α is within the predetermined angle range Rγ. The maximum incident angle γ2 is a maximum value of the angle range Rγ. When the incident angle α is larger than the maximum incident angle γ2, the display light 10 at the other end P2 is reflected toward a region above the eye range ER.

The projection device 3 is disposed such that an angle difference S between an incident angle αx (γ1≤αx≤γ2) included in the aforementioned predetermined angle range Rγ and the Brewster angle β is equal to or less than a predetermined value δ1. That is, the projection device 3 is disposed such that the following Equation (1) is satisfied. The projection device 3 is disposed in this manner, so that the following Equation (2) and Equation (3) are satisfied.

|αx−β|≤δ1 (1)

|γ1−β|≤δ1 (2)

|γ2−β|≤δ1 (3)

The projection device 3 may be disposed such that, for example, the following Equation (4) is satisfied. That is, the projection device 3 may be disposed such that the Brewster angle β is equal to or larger than the minimum incident angle γ1 and is equal to or smaller than the maximum incident angle γ2. In other words, the predetermined angle range Ry may include the Brewster angle β.

γ1≤β≤γ2 (4)

The predetermined value δ1 is determined, for example, on the basis of an upper limit value Rx of the reflection rate Rp of the P wave illustrated in FIG. 6. The upper limit value Rx is an upper limit value that is allowable as the reflection rate Rp of the P wave on the inner glass 11 from the standpoint of suppressing ghost. An angle range α0 is a range of the incident angle α in which the reflection rate Rp of the P wave is equal to or less than the upper limit value Rx. The angle range α0 is the range of the incident angle α from the minimum value α1 to the maximum value α2.

In the example illustrated in FIG. 6, a difference between the Brewster angle § and the maximum value α2 is smaller than a difference between the Brewster angle § and the minimum value α1. In such a case, the predetermined value δ1 may be determined by the following Equation (5). The predetermined value δ1 is determined as in the following Equation (5), so that the brightness of the reflected light 40 can be set to have a value within an allowable range.

δ1=α2−β (5)

Furthermore, the minimum incident angle γl and the maximum incident angle γ2 may also be determined on the basis of the aforementioned angle range α0. In such a case, the projection device 3 is disposed such that, for example, the predetermined angle range Rγ is included in the angle range α0. In other words, the projection device 3 is disposed such that the minimum incident angle γ1 is equal to or larger than the minimum value α1 of the angle range α0 and the maximum incident angle γ2 is equal to or smaller than the maximum value α2 of the angle range α0.

Furthermore, the projection device 3 of the present embodiment is disposed such that a brightness ratio BI between the brightness BR of the reflected light 40 reflected by the windshield 101 and the brightness BD of the diffracted light 30 is equal to or smaller than a predetermined value BT. The brightness BR of the reflected light 40 is, for example, the total value of the brightness BR1 of the first reflected light 40A and the brightness BR2 of the second reflected light 40B. The brightness BR1 of the first reflected light 40A is expressed by the following Equation (6) and the brightness BR2 of the second reflected light 40B is expressed by the following Equation (7). Note that Wt is the transmittance of the windshield 101, Wr is the surface reflection rate on the windshield 101, Hd is the diffraction efficiency of the hologram 2, and Lt is the brightness of the display light 10 incident on the windshield 101.

BR1=Lt×Wr (6)

BR2=Lt×Wr²×Wr (7)

Furthermore, the brightness BD of the diffracted light 30 is expressed by the following Equation (8). The brightness ratio BI is expressed by the following Equation (9).

BD=Lt×Wr²×Hd (8)

BI=(BR1+BR2)/BD (9)

The value of the brightness ratio BI may differ depending on a reflection position on the windshield 101. The projection device 3 is disposed such that, for example, a maximum value of the brightness ratio BI is equal to or smaller than the predetermined value BT. The predetermined value BT is appropriately determined, for example, from the standpoint of improving the visibility of the display image 31. By determining the predetermined value BT to a small value, contrast between the brightness of the display image 31 and the brightness of the reflected light 40 is increased and the reflected light 40 is less conspicuous.

The diffraction efficiency Hd of the hologram 2 and the surface reflection rate Wr of the windshield 101 are determined such that the brightness ratio BI is equal to or smaller than the predetermined value BT or the brightness ratio BI is as small as possible. Note that the surface reflection rate Wr differs depending on the incident angle α of the display light 10 on the windshield 101. Therefore, an optimal arrangement of the projection device 3 is adopted so as to minimize the brightness ratio BI.

As described above, the vehicular display device 1 of the present embodiment has the reflection-type hologram 2 and the projection device 3. The hologram 2 is disposed inside the windshield 101 of the vehicle 100. The hologram 2 has the first surface 21 facing the eye range ER of the vehicle 100. The projection device 3 projects the display light 10 of the P wave toward the first surface 21. The hologram 2 outputs the display light 10, which is incident on the first surface 21 from the projection device 3, as the diffracted light 30 directed to the eye range ER. The hologram 2 has the diffraction characteristics of condensing the diffracted light 30 in the eye range ER.

The projection device 3 is disposed such that a part of the display light 10 is reflected toward the eye range ER when the incident angle α of the display light 10 on the windshield 101 is within the predetermined angle range Rγ. The projection device 3 is disposed such that the angle difference δ between the incident angle αx included in the predetermined angle range Rγ and the Brewster angle β is equal to or smaller than the predetermined value δ1. The predetermined value δ1 may be determined such that the reflection rate Rp of the P wave on the surface 11a on the vehicle interior side is equal to or smaller than the upper limit value Rx.

According to the vehicular display device 1 of the present embodiment, although the projection device 3 is disposed in such a positional relation that the reflected light 40 is directed to the eye range ER, the brightness of the reflected light 40 is reduced. By setting the angle difference δ to be equal to or smaller than the predetermined value δ1, the reflection rate Rp of the display light 10 of the P wave reflected by the surface 11a on the vehicle interior side is suppressed. As a consequence, both the improvement of the visibility of the display image 31 and the improvement of the degree of freedom in the arrangement of the projection device 3 are achieved.

The projection device 3 of the present embodiment is disposed such that the predetermined angle range Rγ includes the Brewster angle β. The predetermined angle range Rγ includes the Brewster angle β, so that the reflection rate Rp is reduced and the visibility of the display image 31 is improved.

The projection device 3 of the present embodiment is disposed such that the brightness ratio BI between the brightness BR of the reflected light 40 reflected by the windshield 101 toward the eye range ER and the brightness BD of the diffracted light 30 is equal to or less than the predetermined value BT. With this, the reflected light 40 is less conspicuous than the diffracted light 30, resulting in the improvement of the visibility of the display image 31.

In the present embodiment, the brightness BR of the reflected light 40 includes the brightness BR1 of the first reflected light 40A and the brightness BR2 of the second reflected light 40B. The first reflected light 40A is light reflected by the surface 11a on the vehicle interior side. The second reflected light 40B is light reflected by the boundary surface 12a between the windshield 101 and the outside of the vehicle after passing through the surface 11a on the vehicle interior side. By so doing, the reflected light 40 becomes less visible, resulting in the improvement of the visibility of the display image 31.

### Modified Example of Embodiment

The modified example of the embodiment will be described. The arrangement and characteristics of the hologram 2 are not limited to the arrangement and characteristics illustrated in the aforementioned embodiment. The predetermined angle range Rγ does not necessarily include the Brewster angle β. The predetermined angle range Rγ is appropriately determined such that it is possible to reduce the reflection rate Rp on the windshield 101.

The contents disclosed in the aforementioned embodiment and modified example can be combined and executed as appropriate.

In the vehicular display device according to the present embodiment, the projection device is disposed such that an angle difference between an incident angle included in a predetermined angle range and the Brewster angle is equal to or smaller than the predetermined value. In accordance with the vehicular display device according to the present embodiment, it is possible to improve the visibility of a display image by suppressing the brightness of reflected light and to improve the degree of freedom in the arrangement of the projection device.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A vehicular display device comprising:
a reflection-type hologram disposed inside a windshield of a vehicle and including a first surface facing a side of an eye range of the vehicle; and
a projection device that projects display light of a P wave toward the first surface, wherein
the hologram outputs the display light, which is incident on the first surface from the projection device, as diffracted light directed to the eye range, and has diffraction characteristics of condensing the diffracted light in the eye range,
the projection device is disposed such that a part of the display light is reflected toward the eye range when an incident angle of the display light on the windshield is within a predetermined angle range, and
the projection device is disposed such that an angle difference between the incident angle included in the predetermined angle range and a Brewster angle is equal to or less a predetermined value.

2. The vehicular display device according to claim 1, wherein
the projection device is disposed such that the predetermined angle range includes the Brewster angle.

3. The vehicular display device according to claim 1, wherein
the projection device is disposed such that a brightness ratio between brightness of reflected light reflected by the windshield toward the eye range and brightness of the diffracted light is equal to or less than a predetermined value.

4. The vehicular display device according to claim 2, wherein
the projection device is disposed such that a brightness ratio between brightness of reflected light reflected by the windshield toward the eye range and brightness of the diffracted light is equal to or less than a predetermined value.

5. The vehicular display device according to claim 3, wherein
the brightness of the reflected light includes brightness of light reflected by a surface of the windshield on a vehicle interior side and brightness of light reflected by a boundary surface between the windshield and an outside of the vehicle after passing through the surface on the vehicle interior side.

6. The vehicular display device according to claim 4, wherein
the brightness of the reflected light includes brightness of light reflected by a surface of the windshield on a vehicle interior side and brightness of light reflected by a boundary surface between the windshield and an outside of the vehicle after passing through the surface on the vehicle interior side.
